(19) United States
(12) Patent Application Publication
(10) Pub. No.: US 2014/0254389 A1
(43) Pub. Date: Sep. 11, 2014

(54) SYSTEMS AND METHODS FOR MONITORING WIRELESS COMMUNICATIONS

(71) Applicant: QUALCOMM INCORPORATED, San Diego, CA (US)

(72) Inventors: Didier Johannes Richard Van Nee, De Meern (NL); Santosh Vasudev Anikhindi, Eastleigh (GB); Vincent Knowles Jones, IV, Redwood City, CA (US)

(73) Assignee: QUALCOMM Incorporated, San Diego, CA (US)

(21) Appl. No.: 13/785,497

(22) Filed: Mar. 5, 2013

(51) Int. Cl. H04L 12/26

(52) U.S. Cl. CPC H04L 43/08
USPC 370/241

(57) ABSTRACT

A method for multi-user multiple-input and multiple-output (MU-MIMO) sniffing by an electronic device is described. The method includes detecting multiple client second control fields concurrently. The method also includes detecting multiple client data fields concurrently. The method additionally includes obtaining data based on the multiple client data fields.

### TECHNICAL FIELD

The present disclosure relates generally to communication systems. More specifically, the present disclosure relates to systems and methods for monitoring wireless communications.

### BACKGROUND

Communication systems are widely deployed to provide various types of communication content such as data, voice, video and so on. These systems may be multiple-access systems capable of supporting simultaneous communication of multiple communication devices (e.g., wireless communication devices, access terminals, etc.) with one or more other communication devices (e.g., base stations, access points, etc.).

Use of communication devices has dramatically increased over the past few years. Communication devices often provide access to a network, such as a Local Area Network (LAN) or the Internet, for example. Other communication devices (e.g., access terminals, laptop computers, smart phones, media players, gaming devices, etc.) may wirelessly communicate with communication devices that provide network access. Some communication devices comply with certain industry standards, such as the Institute of Electrical and Electronics Engineers (IEEE) 802.11 (e.g., Wireless Fidelity or “Wi-Fi”) standards. Communication device users, for example, often connect to wireless networks using such communication devices.

As the use of communication devices has increased, advancements in monitoring wireless communications are being sought. Systems and methods that improve monitoring wireless communications may be beneficial.

### SUMMARY

A method for multi-user multiple-input and multiple-output (MU-MIMO) sniffing by an electronic device is described. The method includes detecting multiple client second control fields concurrently. The method also includes detecting multiple client data fields concurrently. The method additionally includes obtaining data based on the multiple client data fields.

The multiple client second control fields may be multiple client very high throughput signal B (VHT-SIG-B) fields. The multiple client data fields may be multiple client very high throughput (VHT) data fields.

The method may also include deparsing signaling parameters from multiple client first control fields. The multiple client first control fields may be very high throughput signal A (VHT-SIG-A) fields. Deparsing signaling parameters from multiple client first control fields may be performed for a client number. The method may further include deparsing a number of client spatial streams for all other MU-MIMO clients.

The method may additionally include obtaining a MU-MIMO channel estimate for multiple client spatial streams. Detecting multiple client second control fields may be based on the MU-MIMO channel estimate.

The method may also include decoding the multiple client second control fields. The method may further include deparsing multiple client modulation and coding schemes (MCSs) from the multiple client second control fields. Obtaining data based on the multiple client data fields may include performing at least one of deinterleaving, decoding and descrambling for each of the multiple client data fields.

A multi-user multiple-input and multiple-output (MU-MIMO) sniffer is also described. The MU-MIMO sniffer includes control field detection circuitry that detects multiple client second control fields concurrently. The MU-MIMO sniffer also includes data field detection circuitry coupled to the control field detection circuitry. The data field detection circuitry detects multiple client data fields concurrently. The MU-MIMO sniffer further includes data obtaining circuitry coupled to the data field detection circuitry. The data obtaining circuitry obtains data based on the multiple client data fields.

A computer-program product for multi-user multiple-input and multiple-output (MU-MIMO) sniffing is also described. The computer-program product includes a non-transitory tangible computer-readable medium with instructions. The instructions include code for causing a MU-MIMO sniffer to detect multiple client second control fields concurrently. The instructions also include code for causing the MU-MIMO sniffer to detect multiple client data fields concurrently. The instructions additionally include code for causing the MU-MIMO sniffer to obtain data based on the multiple client data fields.

An apparatus for multi-user multiple-input and multiple-output (MU-MIMO) sniffing is also described. The apparatus includes means for detecting multiple client second control fields concurrently. The apparatus also includes means for detecting multiple client data fields concurrently. The apparatus further includes means for obtaining data based on the multiple client data fields.

### BRIEF DESCRIPTION OF THE DRAWINGS

FIG. 1 is a block diagram illustrating one configuration of a multi-user multiple-input and multiple-output (MU-MIMO) sniffer in which systems and methods for monitoring wireless communications may be implemented;

FIG. 2 is a flow diagram illustrating one configuration of a method for monitoring wireless communications;

FIG. 3 is a block diagram illustrating one example of a MU-MIMO sniffer monitoring wireless communications in accordance with the systems and methods disclosed herein;

FIG. 4 is a diagram illustrating one example of a communication frame that may be used in accordance with the systems and methods disclosed herein;

FIG. 5 is a block diagram illustrating a more specific configuration of a MU-MIMO sniffer in which systems and methods for monitoring wireless communications may be implemented;

FIG. 6 is a flow diagram illustrating a more specific configuration of a method for monitoring wireless communications;

FIG. 7 is a flow diagram illustrating another more specific configuration of a method for monitoring wireless communications;

FIG. 8 is a block diagram illustrating one configuration of a MU-MIMO sniffer and a base station in which systems and methods for monitoring wireless communications may be implemented;

FIG. 9 is a block diagram of a MU-MIMO sniffer in which systems and methods for monitoring wireless communications may be implemented; and

FIG. 10 illustrates certain components that may be included within an MU-MIMO sniffer.

### DETAILED DESCRIPTION

Examples of communication devices include cellular telephone base stations or nodes, access points, wireless gateways and wireless routers. A communication device may operate in accordance with certain industry standards, such as the Institute of Electrical and Electronics Engineers (IEEE) 802.11a, 802.11b, 802.11g, 802.11n and/or 802.11ac (e.g., Wireless Fidelity or “Wi-Fi”) standards. Other examples of standards that a communication device may comply with include IEEE 802.16 (e.g., Worldwide Interoperability for Microwave Access or “WiMAX”), Third Generation Partnership Project (3GPP), 3GPP Long Term Evolution (LTE) and others (e.g., where a communication device may be referred to as a NodeB, evolved NodeB (eNB), etc.). While some of the systems and methods disclosed herein may be described in terms of one or more standards, this should not limit the scope of the disclosure, as the systems and methods may be applicable to many systems and/or standards.

Some communication devices (e.g., access terminals, client devices, client stations, etc.) may wirelessly communicate with other communication devices. Some communication devices (e.g., wireless communication devices) may be referred to as mobile devices, mobile stations, subscriber stations, clients, client stations, user equipments (UEs), remote stations, access terminals, mobile terminals, terminals, user terminals, subscriber units, etc. Additional examples of communication devices include laptop or desktop computers, cellular phones, smart phones, wireless modems, e-readers, tablet devices, gaming systems, etc. Some of these communication devices may operate in accordance with one or more industry standards as described above. Thus, the general term “communication device” may include communication devices described with varying nomenclatures according to industry standards (e.g., access terminal, user equipment (UE), remote terminal, access point, base station, Node B, evolved Node B (eNB), etc.).

Some communication devices may be capable of providing access to a communications network. Examples of communications networks include, but are not limited to, a telephone network (e.g., a “land-line” network such as the Public-Switched Telephone Network (PSTN) or cellular phone network), the Internet, a Local Area Network (LAN), a Wide Area Network (WAN), a Metropolitan Area Network (MAN), etc.

Some configurations of the systems and methods disclosed herein describe a MU-MIMO sniffer for devices that operate in accordance with the IEEE 802.11ac specification. The IEEE 802.11ac amendment specifies a MU-MIMO mode in addition to single user multiple-input multiple-output (MIMO) modes. MU-MIMO packets may contain data for up to four different clients with up to eight client spatial (e.g., space-time) streams.

One issue that may arise when testing MU-MIMO networks (e.g., access points or APs) is that conventional sniffers cannot be used. A sniffer is a device that is not the intended receiver of a packet, but that does want to decode the transmitted packet to assess the link quality or debug any network problems. MU-MIMO packets can generally not be sniffed with regular 802.11ac receivers because the average signal to interference plus noise ratio (SINR) will be close to zero decibels (dB) (or potentially less than zero dB) at any location other than the intended MU-MIMO clients. This is because the MU-MIMO beamforming can only provide a good signal to interference plus noise ratio (SINR) at the intended clients.

In some configurations, the systems and methods disclosed herein describe how an existing 802.11ac device may be modified to be used as a MU-MIMO sniffer for 802.11ac MU-MIMO packets. For example, an 802.11ac device that is capable of receiving 802.11ac single-user MIMO packets for two or more client spatial streams may be modified according to the systems and methods disclosed herein to be a MU-MIMO sniffer.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

As used herein, the term “concurrent,” and variations thereof, may mean that two or more events overlap each other in time. However, concurrent events may or may not begin and/or end at the same time.

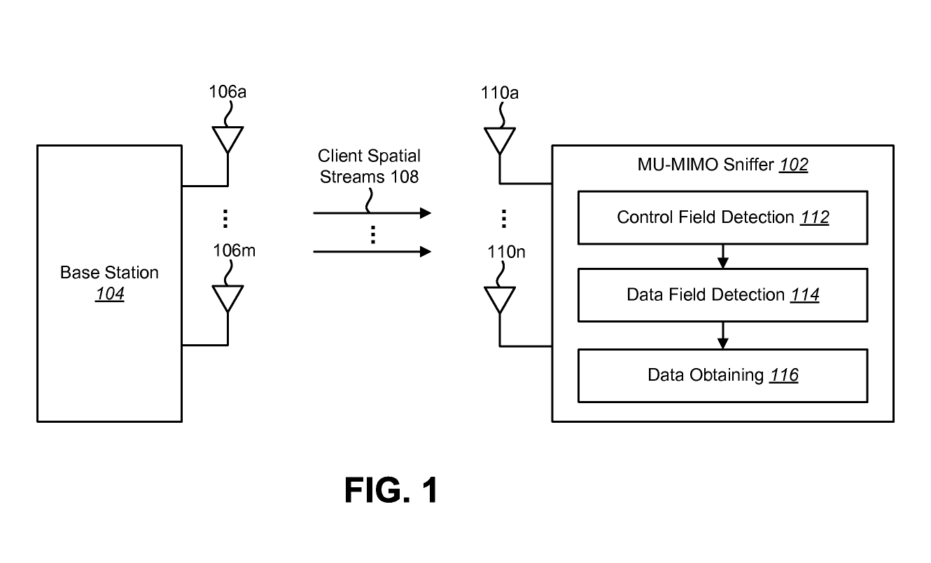

FIG. 1 is a block diagram illustrating one configuration of a multi-user multiple-input and multiple-output (MU-MIMO) sniffer 102 in which systems and methods for monitoring wireless communications may be implemented. In one configuration, a base station 104 transmits two or more client spatial streams 108. Examples of the base station 104 include access points (APs), transmitting communication devices, routers, etc. A base station 104 operating according to 802.11ac MU-MIMO mode may transmit MU-MIMO packets that may contain data for up to four different clients (e.g., wireless communication devices) with up to eight client spatial streams 108 (e.g., space-time streams). For example, the base station 104 may transmit four client spatial streams 108 that include MU-MIMO packets containing data for four separate clients.

The two or more client spatial streams 108 may be MU-MIMO precoded. The base station 104 may transmit the two or more client spatial streams 108 using two or more antennas 106a-m.

The MU-MIMO sniffer 102 is an electronic device that may concurrently receive multiple client spatial streams 108. The MU-MIMO sniffer 102 may receive the two or more client spatial streams 108. It should be noted that in conventional MU-MIMO transmission, beamformed client spatial streams 108 may be aimed at two or more intended clients. Therefore, only the intended clients may receive a clear transmission of the MU-MIMO packet because the beamforming can only provide a good signal to interference plus noise ratio (SINR) at the intended clients. At any other position and any other device (e.g., a non-intended device), the MU-MIMO transmission will include a mixture of MU-MIMO packets that are meant for multiple clients. However, according to the systems and methods described herein, the MU-MIMO sniffer 102 may receive and decode each separate client spatial stream 108.

In one configuration, the MU-MIMO sniffer 102 includes at least as many antennas 110a-n as the total number of client spatial streams 108 sent by the base station 104. The MU-MIMO sniffer 102 may receive and decode each separate client spatial stream 108 intended for two or more clients. For example, the base station 104 may transmit four client spatial streams 108 that include MU-MIMO packets containing data for four separate clients.

The MU-MIMO sniffer 102 may be an 802.11ac receiver that is capable of receiving 802.11ac single-user MIMO packets that is modified according to the systems and methods described herein. In one configuration, the MU-MIMO sniffer 102 may include a programmable option to set the MU-MIMO sniffer 102 in a sniffer mode for decoding one particular client. A client number (e.g., {0, 1, 2, 3}) may be set when enabling the sniffer mode. For every MU-MIMO packet (meaning any Group ID=1, . . . , 62, for example), the MU-MIMO sniffer 102 may perform one or more functions as described below.

The MU-MIMO sniffer 102 may include a control field detection block/module 112. As used herein, the term “block/module” and variations thereof may indicate that a particular element or component may be implemented in hardware (e.g., circuitry), software or a combination of both. In some configurations, the control field detection block/module 112 may be implemented as control field detection circuitry. The control field detection block/module 112 may detect multiple client second control fields concurrently. In some configurations, the multiple client second control fields may include multiple client very high throughput signal B (VHT-SIG-B) fields. For example, the multiple client second control fields may include each of the VHT-SIG-B fields included in the two or more client spatial streams 108.

It should be noted that the terms “first,” “second” and so forth may be used herein to identify and/or distinguish elements. Accordingly, such terms may not necessarily imply a particular order or number of elements. For example, a “second” element may be implemented with or without a “first” element.

The control field detection block/module 112 may perform concurrent MIMO detections for the multiple client second control fields. In one configuration, the control field detection block/module 112 may detect the multiple client second control fields based on a MU-MIMO channel estimate. For example, the control field detection block/module 112 may concurrently perform detections for multiple client second control fields (e.g., VHT-SIG-B fields) based on the full MU-MIMO channel estimate of all of the client spatial streams 108. For instance, the control field detection block/module 112 may use the MU-MIMO channel estimate to perform MIMO detections for the VHT-SIG-B fields included in the two or more client spatial streams 108. The MIMO detections may be performed similarly to a non-beamforming single-user MIMO detection on two or more client spatial streams 108 that each have binary phase-shift keying (BPSK) modulation (up to eight client spatial streams 108 in the case of 802.11ac, for example).

It should be noted that a conventional 802.11ac receiver will only detect the VHT-SIG-B fields intended for that receiver (e.g., client). However, the MU-MIMO sniffer 102 may concurrently detect multiple VHT-SIG-B fields that are meant for different clients.

The MU-MIMO sniffer 102 may include a data field detection block/module 114. In some configurations, the data field detection block/module 114 may be implemented as data field detection circuitry coupled to the coupled to the control field detection circuitry. The data field detection block/module 114 may detect multiple client data fields concurrently. The multiple client data fields may be multiple client very high throughput (VHT) data fields. In one configuration, the data field detection block/module 114 may perform a MIMO detection for all VHT data symbols. The MIMO detection for the VHT data symbols may be based on modulation and coding schemes (MCSs) obtained from the detected multiple client second control fields. One or more of the MCSs may be the same as or different from each other. The MU-MIMO sniffer 102 may be adapted to accept a different constellation type per client spatial stream 108. For example, a conventional single-user MIMO detector may be modified to accept a different constellation type per client spatial stream 108. The data field detection block/module 114 may output the soft values of the intended client (as indicated by the selected client number). Alternatively, the data field detection block/module 114 may output the soft values of each client.

The MU-MIMO sniffer 102 may include a data obtaining block/module 116. In some configurations, the data obtaining block/module 116 may be implemented as data obtaining circuitry coupled to the data field detection circuitry. The data obtaining block/module 116 may obtain data based on the multiple client data fields. For example, the data obtaining block/module 116 may receive the multiple client data fields detected by the data field detection block/module 114.

The data obtaining block/module 116 may perform at least one of deinterleaving, decoding and descrambling for each of the multiple client data fields. For example, the data obtaining block/module 116 may perform at least one of deinterleaving, decoding and descrambling on the soft values that may be output by the data field detection block/module 114. The deinterleaving, decoding and descrambling may be similar to that in single-user reception, but the data obtaining block/module 116 may concurrently perform deinterleaving, decoding and descrambling for multiple client streams 108.

It should be noted that the systems and methods described herein may be performed for each of the one or more MU-MIMO packets received by the MU-MIMO sniffer 102. For example, the MU-MIMO sniffer 102 may decode every MU-MIMO packet (e.g., any Group ID=1 . . . 62) by performing (e.g., repeating) the systems and methods described herein on each MU-MIMO packet.

It should further be noted that one or more of the elements in the MU-MIMO sniffer 102 may be implemented in circuitry. For example, the control field detection block/module 112, the data field detection block/module 114 and/or the data obtaining block/module 116 may be implemented in circuitry.

As used herein, the term “couple,” and variations thereof, may indicate a direct or indirect connection between circuit elements. For example, if a first element is coupled to a second element, the first element may be directly connected to the second element or may be connected to the second element through one or more elements. The elements included in the MU-MIMO sniffer 102 may be coupled as indicated in FIG. 1 (e.g., the arrows between elements indicate couplings). Couplings may be similarly indicated in other Figures that illustrate block diagrams.

Furthermore, one or more of the elements in the MU-MIMO sniffer 102 could be part of the same or a separate circuit. For example, each of the elements of the MU-MIMO sniffer 102 could be implemented in the same integrated circuit. Alternatively, one or more of the elements of the MU-MIMO sniffer 102 could be implemented in a separate integrated circuit.

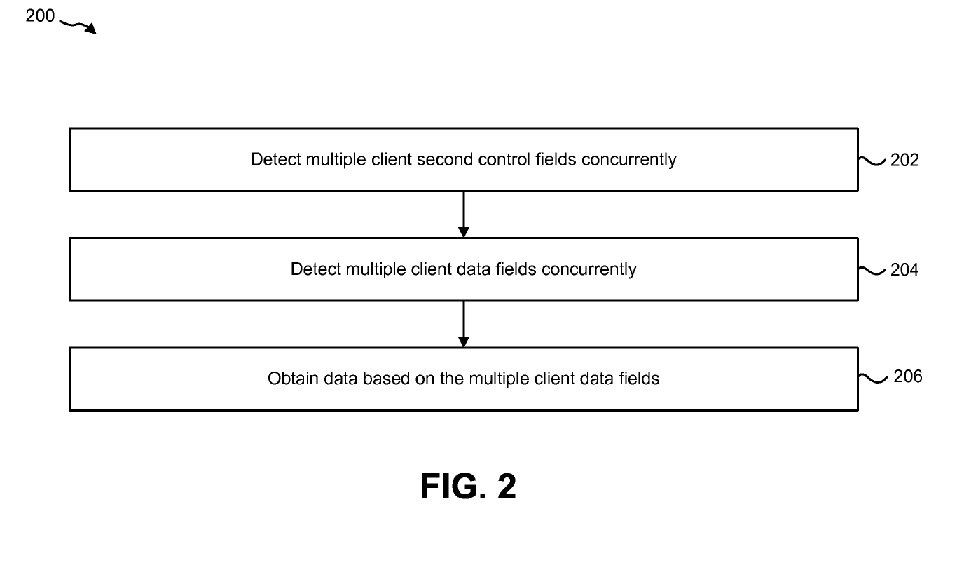

FIG. 2 is a flow diagram illustrating one configuration of a method 200 for monitoring wireless communications. The method 200 may be performed by a MU-MIMO sniffer 102. For example, the MU-MIMO sniffer 102 may detect 202 multiple client second control fields concurrently. In some configurations, the multiple client second control fields may include multiple client VHT-SIG-B fields. For example, the multiple client second control fields may include each of the VHT-SIG-B fields included in two or more client spatial streams 108.

In one configuration, the MU-MIMO sniffer 102 may perform concurrent MIMO detections 202 for the multiple client second control fields based on a MU-MIMO channel estimate. For example, the MU-MIMO sniffer 102 may concurrently perform detections 202 for multiple client second control fields (e.g., VHT-SIG-B fields) based on a full MU-MIMO channel estimate of all of the client spatial streams 108. For instance, the MU-MIMO sniffer 102 may use the MU-MIMO channel estimate to perform MIMO detections 202 for the VHT-SIG-B fields included in the two or more client spatial streams 108.

The MU-MIMO sniffer 102 may detect 204 multiple client data fields concurrently. The multiple client data fields may be multiple client VHT data fields. In one configuration, the MU-MIMO sniffer 102 may perform a MIMO detection 204 for all VHT data symbols. The MIMO detection 204 for the VHT data symbols may be based on modulation and coding schemes (MCSs) obtained from the detected 202 multiple client second control fields. The MU-MIMO sniffer 102 may be configured to accept a different constellation type per client spatial stream 108. The MU-MIMO sniffer 102 may determine the soft values for the intended client. Alternatively, the MU-MIMO sniffer 102 may determine the soft values of each client.

The MU-MIMO sniffer 102 may obtain 206 data based on the multiple client data fields. For example, the MU-MIMO sniffer 102 may obtain 206 data by performing at least one of deinterleaving, decoding and descrambling for each of the multiple client data fields. The MU-MIMO sniffer 102 may perform at least one of deinterleaving, decoding and descrambling on the soft values that may be determined by the MU-MIMO sniffer 102. The MU-MIMO sniffer 102 may concurrently perform deinterleaving, decoding and descrambling for multiple client streams 108.

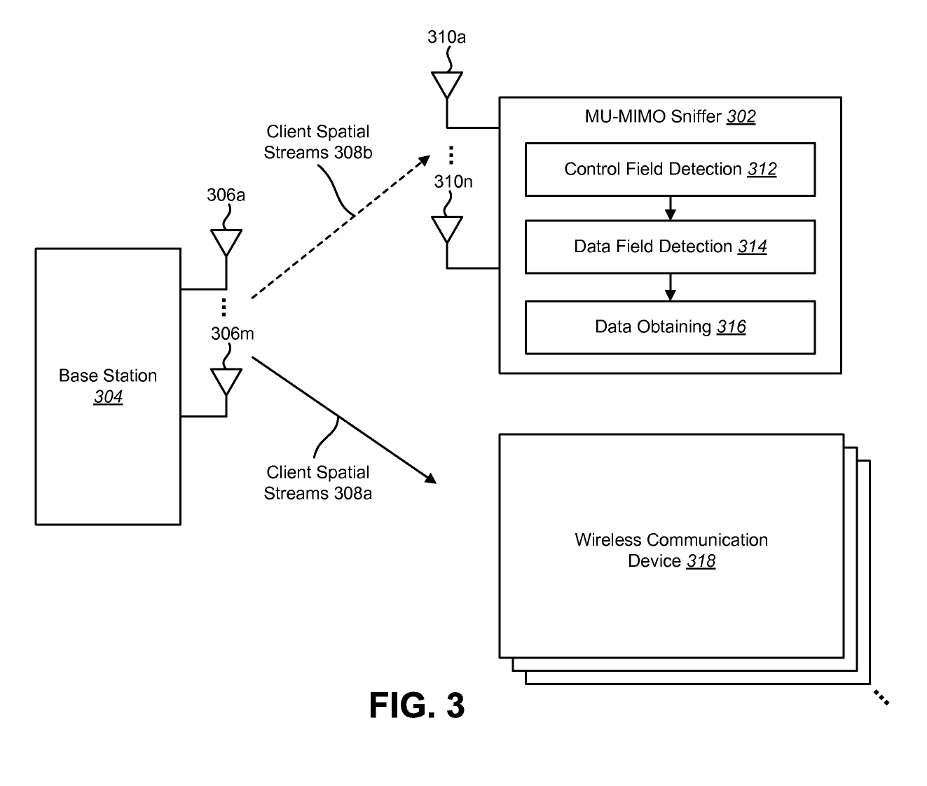

FIG. 3 is a block diagram illustrating one example of a MU-MIMO sniffer 102 monitoring wireless communications in accordance with the systems and methods disclosed herein. In this example, a base station 304 may use two or more antennas 306a-m to transmit two or more client spatial streams 308a to two or more wireless communication devices 318. The wireless communication devices 318 are the intended recipients of a MU-MIMO transmission from the base station 304.

The two or more client spatial streams 308 may be transmitted by the base station 304. Each client spatial stream 308 may be transmitted by a separate antenna 306.

With MU-MIMO beamformed client spatial streams 308, the wireless communication devices 318 may receive a clear transmission of the MU-MIMO packet because the beamforming provides a good signal to interference plus noise ratio (SINR) at the intended clients. At any other position and any other device (e.g., a non-intended device), the MU-MIMO transmission will include a mixture of MU-MIMO packets that are meant for multiple clients. It should be noted that the MU-MIMO sniffer 102 may or may not be one of the intended recipients of the client spatial streams 308b. Accordingly, the transmission received at the MU-MIMO sniffer 302 may include a mixture of MU-MIMO packets intended for one or more wireless communication devices 318.

The MU-MIMO sniffer 302 may receive the client spatial streams 308b using the antennas 310a-n for the two or more client spatial streams 308b. The MU-MIMO sniffer 302 may include a control field detection block/module 312. The control field detection block/module 312 may detect multiple client second control fields (e.g., VHT-SIG-B fields) concurrently as described above in connection with FIG. 1.

The MU-MIMO sniffer 302 may also include a data field detection block/module 314. The data field detection block/module 314 may detect multiple client data fields (e.g., VHT data fields) concurrently. The data field detection block/module 314 may perform a MIMO detection for all VHT data symbols as described above in connection with FIG. 1.

The MU-MIMO sniffer 302 may additionally include a data obtaining block/module 316. The data obtaining block/module 316 may obtain data based on the multiple client data fields detected by the data field detection block/module 314 as described above in connection with FIG. 1.

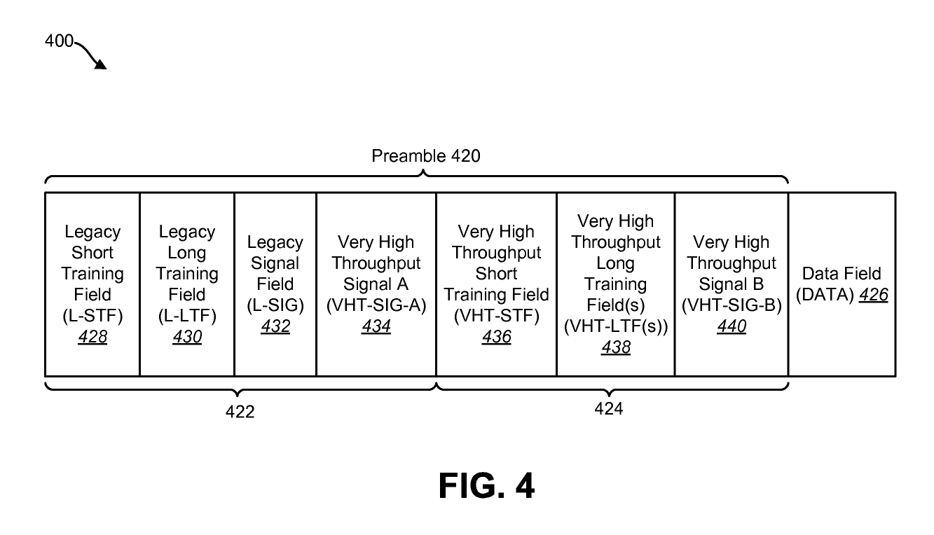

FIG. 4 is a diagram illustrating one example of a communication frame 400 that may be used in accordance with the systems and methods disclosed herein. The frame 400 may include one or more sections or fields for preamble symbols, pilot symbols and/or data symbols. For example, the frame 400 may comprise an IEEE 802.11ac preamble 420 and a data field 426 (e.g., DATA or VHT DATA field). In one configuration, the preamble 420 may have a duration of 40 to 68 microseconds (ns). The preamble 420 and/or pilot symbols may be used (by an MU-MIMO sniffer 102, for example) to synchronize, detect, demodulate and/or decode preamble data (e.g., overhead data) and/or payload data included in the frame 400.

The frame 400 with a preamble 420 may be structured including several fields. In one configuration, an 802.11ac frame 400 may include a legacy short training field or non-high throughput short training field (L-STF) 428, a legacy long training field or non-high throughput long training field (L-LTF) 430, a legacy signal field or non-high throughput signal field (L-SIG) 432, one or more very high throughput signal A (VHT-SIG-A) fields 434, a very high throughput short training field (VHT-STF) 436, one or more very high throughput long training fields (VHT-LTFs) 438, a very high throughput signal B (VHT-SIG-B) field 440 and a data field (DATA) 426.

The preamble 420 may accommodate MU-MIMO. The first part (or portion) 422 of the preamble 420 may be transmitted in an omnidirectional fashion (using cyclic diversity or another scheme, for example). Alternatively, this first part or omnidirectional part 422 may be beamformed. This first part 422 of the preamble 420 may include the L-STF 428, L-LTF 430, L-SIG 432 and VHT-SIG-A 434.

A second part or portion 424 of the preamble 420 may be transmitted in an omnidirectional fashion, may be beamformed or may be MU-MIMO precoded. This second part 424 of the preamble 420 includes the VHT-STF 436, one or more VHT-LTFs 438 and the VHT-SIG-B 440. The data symbols (in the data field 426, for example) may be transmitted with the same or different antenna pattern as the second part 424 of the preamble 420. The data field 426 may also be MU-MIMO precoded.

The preamble 420 may include some control data that is decodable by legacy 802.11a and 802.11n receivers. This control data is contained in the L-SIG 432. The data in the L-SIG 432 informs all receivers how long the transmission will occupy the wireless medium, so that all devices may defer their transmissions for an accurate amount of time. Additionally, the preamble 420 allows 802.11ac devices to distinguish the transmission as an 802.11ac transmission (and avoid determining that the transmission is in an 802.11a or 802.11n format). Furthermore, the preamble 420 may cause legacy 802.11a and 802.11n devices to detect the transmission as an 802.11a transmission, which is a valid transmission with valid data in the L-SIG 432.

In one example, the preamble 420 starts with a first part 422 that may be used for an 802.11a-based legacy deferral and for conveying 802.11ac information such as the length of a downlink MU-MIMO packet and bandwidth. The preamble 420 may include some signaling specific to a receiving wireless communication device 318 (e.g., client-specific signaling), such as a modulation and coding scheme (MCS) in a steered VHT-SIG-B 440 symbol.

The MU-MIMO sniffer 302 may receive a communication frame 400 in accordance with the systems and methods disclosed herein. For example, the MU-MIMO sniffer 302 may receive multiple client spatial streams 308b intended for multiple wireless communication devices 318 as described above in connection with FIG. 3.

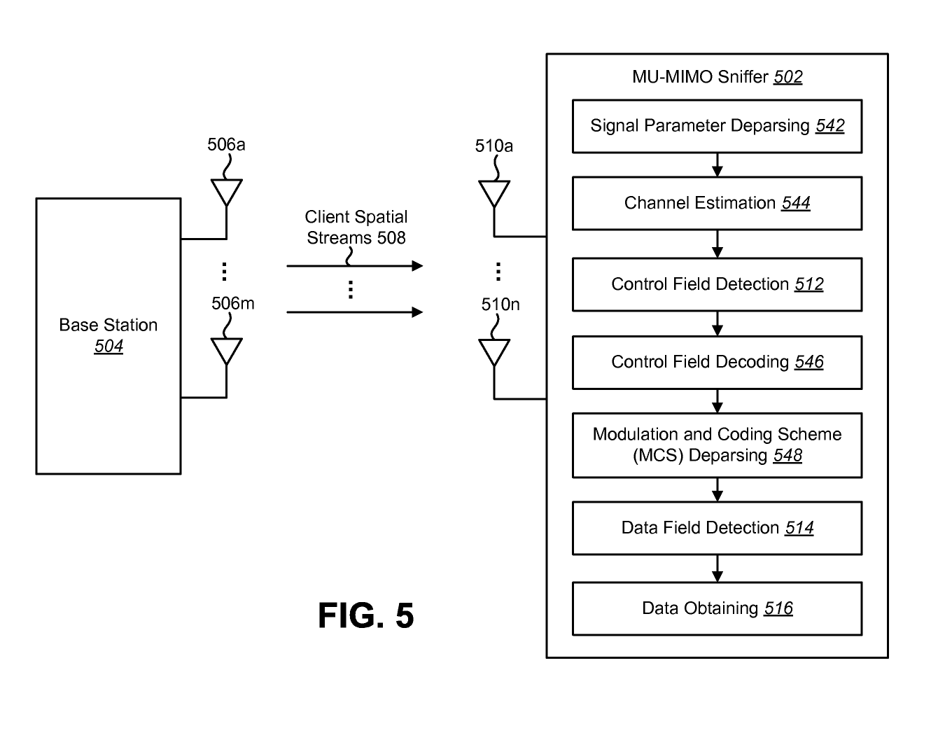

FIG. 5 is a block diagram illustrating a more specific configuration of a MU-MIMO sniffer 502 in which systems and methods for monitoring wireless communications may be implemented. In one configuration, a base station 504 transmits two or more client spatial streams 508. For example, the base station 504 may transmit four client spatial streams 508 that include MU-MIMO packets containing data for four separate clients. The base station 504 may transmit the two or more client spatial streams 508 using two or more antennas 506a-m.

The MU-MIMO sniffer 502 may receive the two or more client spatial streams 508. For example, the MU-MIMO sniffer 502 may receive the two or more client spatial streams 508 using antennas 510a-n. The MU-MIMO sniffer 502 may include at least as many antennas 510a-n as the total number of client spatial streams 508 sent by the base station 504. The MU-MIMO sniffer 502 may receive and decode each separate client spatial stream 508 intended for the two or more clients 318. In one example, the base station 504 may transmit four client spatial streams 508 that include MU-MIMO packets containing data for four separate clients 318.

The MU-MIMO sniffer 502 may include a programmable option to set the MU-MIMO sniffer 502 in a sniffer mode for decoding the client spatial stream 508 for one particular client 318. Additionally or alternatively, the MU-MIMO sniffer 502 may decode the client spatial streams 508 for all clients 318 concurrently. A client number (e.g., {0, 1, 2, 3} may be set when enabling sniffer mode. For every MU-MIMO packet (meaning any Group ID=1, . . . , 62, for example) the MU-MIMO sniffer 502 may perform one or more of the functions described below.

The MU-MIMO sniffer 502 may include a signal parameter deparsing block/module 542. In some configurations, the signal parameter deparsing block/module 542 may be implemented as signal parameter deparsing circuitry coupled to the control field detection circuitry. The signal parameter deparsing block/module 542 may deparse signaling parameters from multiple client first control fields. The MU-MIMO sniffer 502 may deparse signaling parameters from multiple client first control fields included in the two or more client spatial streams 508. The multiple client first control fields may be very high throughput signal A (VHT-SIG-A) fields.

In some configurations, deparsing the signaling parameters from the multiple client first control fields includes reading the preamble of a MU-MIMO packet and decoding the multiple client first control fields to determine how many client spatial streams 508 are transmitted (e.g., how many clients 318 have corresponding transmissions included in the MU-MIMO packet). The MU-MIMO sniffer 502 may deparse the signaling parameters from the multiple client first control fields for the prescribed client 318 (e.g., client number). The MU-MIMO sniffer 502 may also deparse the signaling parameters from the multiple client first control fields for each of the other MU-MIMO clients 318. In some configurations, the MU-MIMO sniffer 502 may deparse the signaling parameters from the multiple client first control fields for each client 318 concurrently.

The MU-MIMO sniffer 502 may include a channel estimation block/module 544. In some configurations, the channel estimation block/module 544 may be implemented as channel estimation circuitry coupled to the control field detection circuitry. The channel estimation block/module 544 may obtain a MU-MIMO channel estimate for multiple client spatial streams 508. For example, the channel estimation block/module 544 may estimate the full MU-MIMO channel for all client spatial streams 508 for all clients. Upon deparsing the signaling parameters from the multiple client first control fields, the MU-MIMO sniffer 502 may obtain a MU-MIMO channel estimate corresponding to all of the client spatial streams 508 based on the very high throughput long training field (VHT-LTF) symbols. The MU-MIMO channel estimate may take the form of an AxS matrix, where A is the number of antennas on the MU-MIMO sniffer 502 and S is the number of client spatial streams 508. In one example, three clients may each receive one client spatial stream 508 from the base station 504. If the MU-MIMO sniffer 502 includes fours antennas, then the channel estimate is a 4×3 matrix.

The MU-MIMO sniffer 502 may include a control field detection block/module 512. The control field detection block/module 512 may detect multiple client second control fields concurrently. In some configurations, the multiple client second control fields may include multiple client very high throughput signal B (VHT-SIG-B) fields. For example, the multiple client second control fields may include each of the VHT-SIG-B fields included in the two or more client spatial streams 508.

The control field detection block/module 512 may concurrently perform detections for multiple client second control fields based on the full MU-MIMO channel estimate of all of the client spatial streams 508 that may be obtained by the channel estimation block/module 544. For example, the control field detection block/module 512 may use the MU-MIMO channel estimate to perform MIMO detections for the VHT-SIG-B fields included in the two or more client spatial streams 508.

The MU-MIMO sniffer 502 may include a control field decoding block/module 546. In some configurations, the control field decoding block/module 546 may be implemented as control field decoding circuitry coupled to the control field detection circuitry. The control field decoding block/module 546 may decode multiple client second control fields. For example, upon detecting the multiple client second control fields (by the control field detection block/module 512, for instance), the control field decoding block/module 546 may decode the multiple client second control fields for all clients. In some configurations, a MU-MIMO sniffer 502 equipped with 802.11ac (e.g., a Wi-Fi 2.0 chip that supports 802.11ac MU-MIMO) may include multiple decoders to support the top rate of decoding. These decoders may be Viterbi decoders. The decoders may be used to decode multiple client second control fields concurrently. In one example, a MU-MIMO sniffer 502 that is equipped with three decoders may decode up to three VHT-SIG-B symbols concurrently.

The MU-MIMO sniffer 502 may include a modulation and coding scheme (MCS) deparsing block/module 548. In some configurations, the MCS deparsing block/module 548 may be implemented as MCS deparsing circuitry coupled to the data field detection circuitry. The MCS deparsing block/module 548 may deparse MCSs from the multiple client second control fields. The MCS deparsing block/module 548 may deparse a MCS for all clients based on the decoded multiple client second control fields. For example, the MCS deparsing block/module 548 may deparse the MCSs for all clients from the decoded VHT-SIG-B symbols. In one configuration, the MCS deparsing block/module 548 may only determine the quadrature amplitude modulation (QAM) constellation type for all clients other than the intended client.

The MU-MIMO sniffer 502 may include a data field detection block/module 514. The data field detection block/module 514 may detect multiple client data fields concurrently. In one configuration, the multiple client data fields may be multiple client very high throughput (VHT) data fields. In one configuration, the data field detection block/module 514 may perform a MIMO detection for all VHT data symbols. The MU-MIMO sniffer 502 may be configured to accept a different constellation type per client spatial stream 508. For example, a conventional single-user MIMO detector may be modified to accept a different constellation type per client spatial stream 508. The data field detection block/module 514 may output the soft values corresponding to one or more client numbers. For example, the data field detection block/module 514 may output the soft values of each client.

The MU-MIMO sniffer 502 may include a data obtaining block/module 516. The data obtaining block/module 516 may obtain data based on the multiple client data fields. For example, the data obtaining block/module 516 may perform at least one of deinterleaving, decoding and descrambling for each of the multiple client data fields. In some configurations, the data obtaining block/module 516 may perform at least one of deinterleaving, decoding and descrambling on the soft values that may be output by the data field detection block/module 514. The deinterleaving, decoding and descrambling may be similar to that in single-user reception, but the data obtaining block/module 516 may concurrently perform deinterleaving, decoding and descrambling for multiple client streams 508.

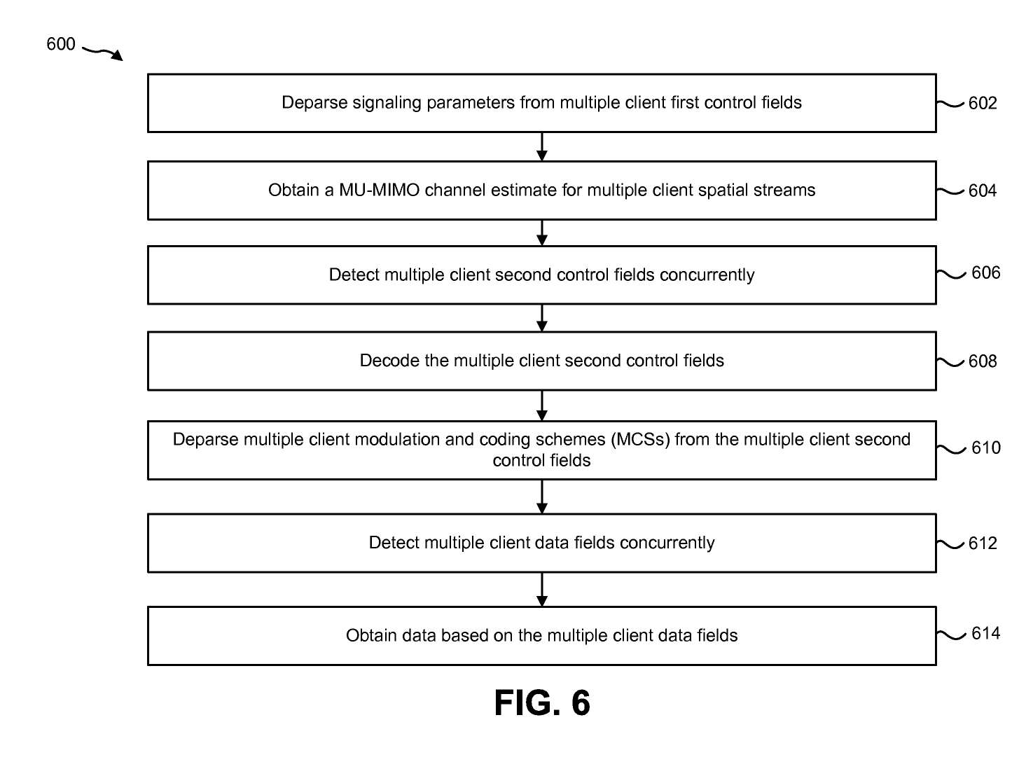

FIG. 6 is a flow diagram illustrating a more specific configuration of a method 600 for monitoring wireless communications. The method 600 may be performed by a MU-MIMO sniffer 502. In one configuration, a MU-MIMO sniffer 502 may receive two or more client spatial streams 508 using antennas 510a-n. The MU-MIMO sniffer 502 may include at least as many antennas 510a-n as the total number of client spatial streams 508 received by the MU-MIMO sniffer 502. For example, the MU-MIMO sniffer 502 may include at least as many antennas 510a-n as the total number of client spatial streams 508 sent by a base station 504.

The MU-MIMO sniffer 502 may deparse 602 signaling parameters from multiple client first control fields. The MU-MIMO sniffer 502 may deparse 602 signaling parameters from multiple client first control fields included in the two or more client spatial streams 508. The multiple client first control fields may be very high throughput signal A (VHT-SIG-A) fields.

In some configurations, deparsing 602 the signaling parameters from the multiple client first control fields includes reading the preamble of a MU-MIMO packet and decoding the multiple client first control fields to determine how many clients are included in the MU-MIMO packet and how many client spatial streams 508 each client receives. The MU-MIMO sniffer 502 may deparse 602 the signaling parameters from the multiple client first control fields for a prescribed client. The MU-MIMO sniffer 502 may also deparse 602 the signaling parameters from the multiple client first control fields for each of the other MU-MIMO clients. The MU-MIMO sniffer 502 may deparse 602 the signaling parameters from the multiple client first control fields for each client concurrently.

The MU-MIMO sniffer 502 may obtain 604 a MU-MIMO channel estimate for multiple client spatial streams 508. For example, the MU-MIMO sniffer 502 may estimate the full MU-MIMO channel for all client spatial streams 508 for all clients. Upon deparsing 602 the signaling parameters from the multiple client first control fields, the MU-MIMO sniffer 502 may obtain 604 a MU-MIMO channel estimate for each of the client spatial streams 508. The MU-MIMO channel estimate may take the form of a matrix as described above in connection with FIG. 5.

The MU-MIMO sniffer 502 may detect 606 multiple client second control fields concurrently. For example, the MU-MIMO sniffer 502 may concurrently detect 606 multiple client second control fields based on the obtained 604 full MU-MIMO channel estimate of all of the client spatial streams 508. The MU-MIMO sniffer 502 may use the MU-MIMO channel estimate to perform MIMO detections 606 for the very high throughput signal B (VHT-SIG-B) fields included in the two or more client spatial streams 508.

The MU-MIMO sniffer 502 may decode 608 multiple client second control fields. For example, upon detecting 606 the multiple client second control fields, the MU-MIMO sniffer 502 may decode 608 the multiple client second control fields. In some configurations, the MU-MIMO sniffer 502 may include multiple decoders (e.g., multiple Viterbi decoders) that may be used to decode 608 multiple client second control fields concurrently. For example, a MU-MIMO sniffer 502 that is equipped with three decoders may decode 608 up to three VHT-SIG-B symbols concurrently.

The MU-MIMO sniffer 502 may deparse 610 multiple client modulation and coding schemes (MCSs) from the multiple client second control fields. For example, MU-MIMO sniffer 502 may deparse 610 the MCSs for all clients from the decoded 608 VHT-SIG-B symbols. In one configuration, the MU-MIMO sniffer 502 may only determine the quadrature amplitude modulation (QAM) constellation type for all clients other than the intended client.

The MU-MIMO sniffer 502 may detect 612 multiple client data fields concurrently. The multiple client data fields may be multiple client very high throughput (VHT) data fields. In one configuration, the MU-MIMO sniffer 502 may perform a MIMO detection 612 for all VHT data symbols. The MU-MIMO sniffer 502 may be configured to accept a different constellation type per client spatial stream 508. The MU-MIMO sniffer 502 may determine the soft values corresponding to one or more client numbers. For example, the MU-MIMO sniffer 502 may determine the soft values for all clients.

The MU-MIMO sniffer 502 may obtain 614 data based on the multiple client data fields. For example, the MU-MIMO sniffer 502 may perform at least one of deinterleaving, decoding and descrambling for each of the multiple client data fields. The MU-MIMO sniffer 502 may perform at least one of deinterleaving, decoding and descrambling on the soft values that may be determined by the MU-MIMO sniffer 502. The deinterleaving, decoding and descrambling may be the similar to that in single-user reception, but the MU-MIMO sniffer 502 may concurrently perform deinterleaving, decoding and descrambling for multiple client streams 508.

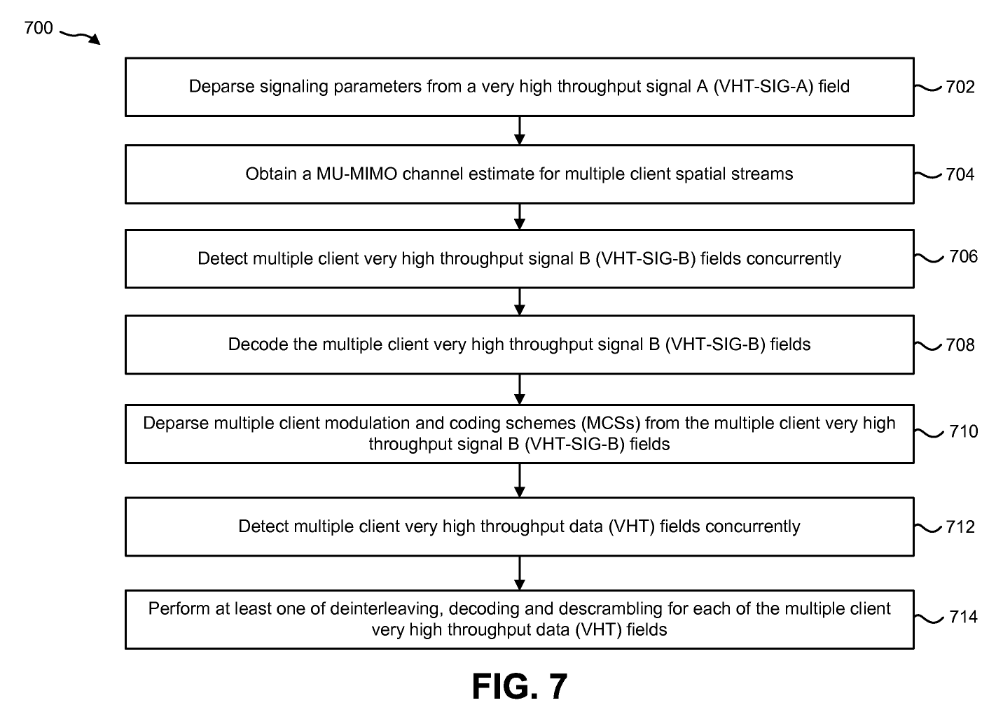

FIG. 7 is a flow diagram illustrating another more specific configuration of a method 700 for monitoring wireless communications. In particular, the method 700 is described specifically in terms of 802.11ac nomenclature. One or more of the procedures described in connection with FIG. 7 may be performed as described in connection with FIG. 6. The method 700 may be performed by a MU-MIMO sniffer 502 as described in connection with FIG. 5.

The MU-MIMO sniffer 502 may deparse 702 signaling parameters from a very high throughput signal A (VHT-SIG-A) field. The MU-MIMO sniffer 502 may obtain 704 a MU-MIMO channel estimate for multiple client spatial streams 508. The MU-MIMO sniffer 502 may detect 706 multiple client VHT-SIG-B fields concurrently.

The MU-MIMO sniffer 502 may decode 708 multiple client VHT-SIG-B fields. The MU-MIMO sniffer 502 may deparse 710 multiple client modulation and coding schemes (MCSs) from the multiple client VHT-SIG-B fields. The MU-MIMO sniffer 502 may detect 712 multiple client very high throughput (VHT) data fields concurrently. The MU-MIMO sniffer 502 may perform 714 at least one of deinterleaving, decoding and descrambling for each of the multiple client very high throughput (VHT) data fields.

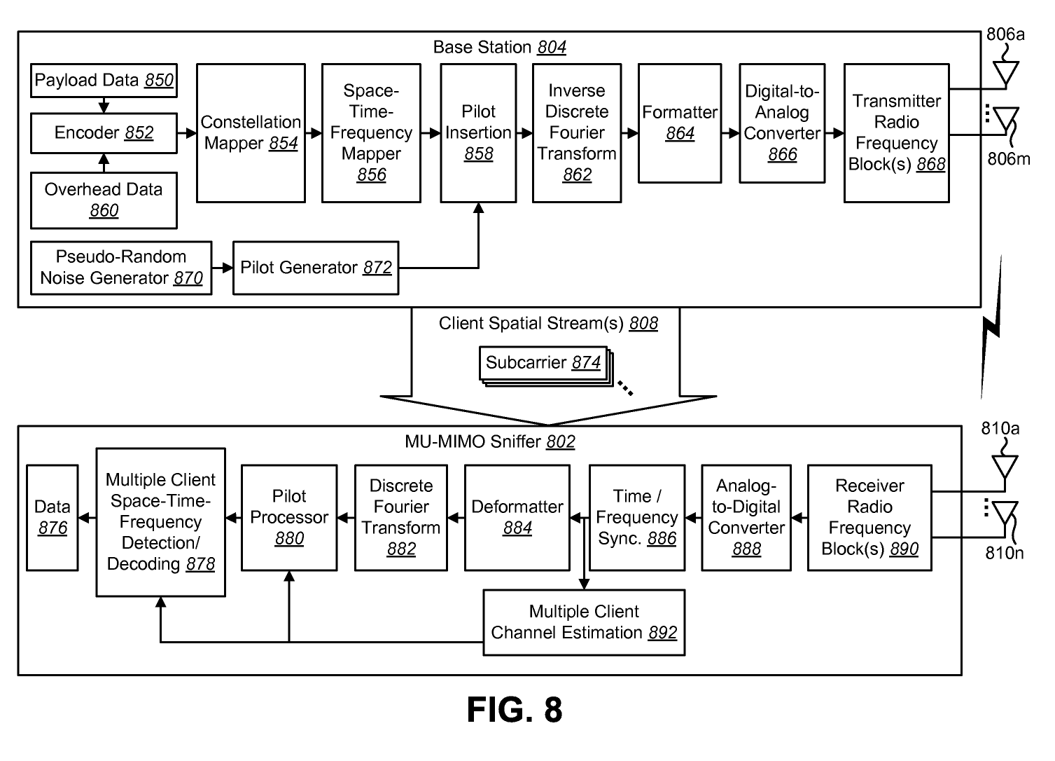

FIG. 8 is a block diagram illustrating one configuration of a MU-MIMO sniffer 802 and a base station 804 in which systems and methods for monitoring wireless communications may be implemented. Examples of the base station 804 include access points, routers, etc. The MU-MIMO sniffer 802 may be similar to one or more of the MU-MIMO sniffers 102, 302, 502 discussed in connection with FIG. 1, FIG. 3 and FIG. 5. The base station 804 may include an encoder 852 with an input for receiving payload data 850 and/or overhead data 860 to be transmitted to one or more receiving wireless communication devices 318 (e.g., the MU-MIMO clients). The MU-MIMO sniffer 802 may additionally receive the (encoded) data 850, 860.

The payload data 850 may include voice, video, audio and/or other data. The overhead data 860 may include control information, such as information that specifies a data rate, modulation and coding scheme (MCS), channel bandwidth, frame length, defer periods, media access control (MAC) information (e.g., clear to send (CTS) information), channel information requests (e.g., channel state information (CSI) requests), etc. The encoder 852 might encode data 850, 860 for forward error correction (FEC), encryption, packeting and/or other encodings known for use with wireless transmission.

A constellation mapper 854 maps the data provided by the encoder 852 into constellations. For instance, the constellation mapper 854 may use modulation schemes such as binary phase-shift keying (BPSK), quadrature amplitude modulation (QAM), etc. Where quadrature-amplitude modulation (QAM) is used, for example, the constellation mapper 854 might provide two bits per client spatial stream 808, per data subcarrier 874, per symbol period. Furthermore, the constellation mapper 854 may output a 16-QAM constellation signal for each client spatial stream 808, for each data subcarrier 874, for each symbol period. Other modulations may be used, such as 64-QAM, which would result in a consumption of six bits per client spatial stream 808, per data subcarrier 874, per symbol period. Other variations are also possible.

The output of the constellation mapper 854 is provided to a space-time-frequency mapper 856 that maps the data onto spatial-time-frequency (STF) dimensions of the transmitter. The dimensions represent various constructs or resources that allow for data to be allocated. A given bit or set of bits (e.g., a grouping of bits, a set of bits that correspond to a constellation point, etc.) may be mapped to a particular place among the dimensions. In general, bits and/or signals mapped to different places among the dimensions are transmitted from the base station 804 such that they are expected to be, with some probability, differentiable at one or more receiving wireless communication device and the MU-MIMO sniffer 802. In one configuration, the space-time-frequency mapper 856 may perform space-time block coding (STBC).

Two or more client spatial streams 808 may be transmitted from the base station 804 such that the transmissions on different client spatial streams 808 may be differentiable at a receiver (with some probability). For example, bits mapped to one spatial dimension are transmitted as one client spatial stream 808. That client spatial stream 808 might be transmitted on its own antenna 806 spatially separate from other antennas 806, its own orthogonal superposition over a plurality of spatially separated antennas 806, its own polarization, etc. Many techniques for client spatial stream 808 separation (involving separating antennas 806 in space or other techniques that would allow their signals to be distinguished at a receiver, for example) are known and can be used.

In the example shown in FIG. 8, there are two or more client spatial streams 808 that are transmitted using the same or a different number of antennas 806a-m (e.g., one or more). In some instances, only one client spatial stream 808 might be available because of inactivation of one or more other client spatial streams 808.

In the case that the base station 804 uses a plurality of frequency subcarriers 874, there are multiple values for the frequency dimension, such that the space-time-frequency mapper 856 might map some bits to one frequency subcarrier 874 and other bits to another frequency subcarrier 874. Other frequency subcarriers 874 may be reserved as guard bands, pilot tone subcarriers, or the like that do not (or do not always) carry data 850, 860. For example, there may be one or more data subcarriers 874 and one or more pilot subcarriers 874. It should be noted that, in some instances or configurations, not all subcarriers 874 may be excited at once. For instance, some tones may not be excited to enable filtering. In one configuration, the base station 804 may utilize orthogonal frequency-division multiplexing (OFDM) for the transmission of multiple subcarriers 874. For instance, the space-time-frequency mapper 856 may map (encoded) data 850, 860 to space, time and/or frequency resources according to the multiplexing scheme used.

The time dimension refers to symbol periods. Different bits may be allocated to different symbol periods. Where there are multiple client spatial streams 808, multiple subcarriers 874 and multiple symbol periods, the transmission for one symbol period might be referred to as an “OFDM (orthogonal frequency-division multiplexing) MIMO (multiple-input, multiple-output) symbol.” A transmission rate for encoded data may be determined by multiplying the number of bits per simple symbol (e.g., log₂ of the number of constellations used) times the number of client spatial streams 808 times the number of data subcarriers 874, divided by the length of the symbol period.

Thus, the space-time-frequency mapper 856 may map bits (or other units of input data) to one or more client spatial streams 808, data subcarriers 874 and/or symbol periods. Separate client spatial streams 808 may be generated and/or transmitted using separate paths. In some implementations, these paths are implemented with distinct hardware, whereas in other implementations, the path hardware is reused for more than one client spatial stream 808 or the path logic is implemented in software that executes for one or more client spatial streams 808. More specifically, each of the elements illustrated in the base station 804 may be implemented as a single block/module or as multiple blocks/modules. For instance, the transmitter radio frequency block(s) 868 element may be implemented as a single block/module or as multiple parallel blocks/modules corresponding to each antenna 806a-m (e.g., each client spatial stream 808).

The base station 804 may include a pilot generator block/module 872. The pilot generator block/module 872 may generate a pilot sequence. A pilot sequence may be a group of pilot symbols. In one configuration, for instance, the values in the pilot sequence may be represented by a signal with a particular phase, amplitude and/or frequency. For example, a “1” may denote a pilot symbol with a particular phase and/or amplitude, while a “−1” may denote a pilot symbol with a different (e.g., opposite or inverse) phase and/or amplitude.

The base station 804 may include a pseudo-random noise generator 870 in some configurations. The pseudo-random noise generator 870 may generate a pseudo-random noise sequence or signal (e.g., values) used to scramble the pilot sequence. For example, the pilot sequence for successive OFDM symbols may be multiplied by successive numbers from the pseudo-random noise sequence, thereby scrambling the pilot sequence per OFDM symbol. When the pilot sequence is sent to a MU-MIMO sniffer 802, the received pilot sequence may be unscrambled by a pilot processor 880.

The output(s) of the space-time-frequency mapper 856 may be spread over frequency and/or spatial dimensions. A pilot insertion block/module 858 inserts pilot tones into the pilot tone subcarriers 874. For example, the pilot sequence may be mapped to subcarriers 874 at particular indices. For instance, pilot symbols from the pilot sequence may be mapped to subcarriers 874 that are interspersed with data subcarriers 874 and/or other subcarriers 874. In other words, the pilot sequence or signal may be combined with the data sequence or signal. In some configurations, one or more direct current (DC) tones may be centered at index 0.

The data and/or pilot signals are provided to an inverse discrete Fourier transform (IDFT) block/module 862. The inverse discrete Fourier transform (IDFT) block/module 862 converts the frequency signals of the data 850, 860 and inserted pilot tones into time domain signals representing the signal over the client spatial streams 808 and/or time-domain samples for a symbol period. In one configuration, for example, the IDFT block/module 862 may perform a 256-point inverse fast Fourier transform (IFFT).

The time-domain signal is provided to a formatter 864. The formatter (e.g., one or more formatting blocks/modules) 864 may take the output of the inverse discrete Fourier transform (IDFT) block/module 862, convert the output from parallel signals to serial (P/S), add a cyclical prefix and/or perform guard interval windowing, etc.

The formatter 864 output may be provided to a digital-to-analog converter (DAC) 866. The digital-to-analog converter (DAC) 866 may convert the formatter 864 output from one or more digital signals to one or more analog signals. The digital-to-analog converter (DAC) 866 may provide the analog signal(s) to one or more transmitter radio frequency (TX RF) blocks 868.

The one or more transmitter radio frequency blocks 868 may be coupled to or include a power amplifier. The power amplifier may amplify the analog signal(s) for transmission. The one or more transmitter radio frequency blocks 868 may output radio frequency (RF) signals to one or more antennas 806a-m, thereby transmitting the data 850, 860 that was input to the encoder 852 over a wireless medium suitably configured for receipt by one or more receiving wireless communication devices and/or the MU-MIMO sniffer 802.

An MU-MIMO sniffer 802 may receive and use signals from the base station 804. For example, a MU-MIMO sniffer 802 may include one or more antennas 810a-n (which may be greater than, or equal to, the number of base station 804 antennas 806a-m and/or the number of client spatial streams 808) that feed to one or more receiver radio frequency (RX RF) blocks 890.

The one or more receiver radio frequency (RX RF) blocks 890 may output analog signals to one or more analog-to-digital converters (ADCs) 888. For example, a receiver radio frequency block 890 may receive and downconvert a signal, which may be provided to an analog-to-digital converter 888. As with the base station 804, the number of client spatial streams 808 processed may or may not be equal to the number of antennas 810a-n. Furthermore, each client spatial stream 808 need not be limited to one antenna 810, as various beamsteering, orthogonalization, etc., techniques may be used to arrive at a plurality of receiver streams.

The one or more analog-to-digital converters (ADCs) 888 may convert the received analog signal(s) to one or more digital signal(s). These output(s) of the one or more analog-to-digital converters (ADCs) 888 may be provided to one or more time and/or frequency synchronization blocks/modules 886. A time and/or frequency synchronization block/module 886 may (attempt to) synchronize or align the digital signal in time and/or frequency (to a MU-MIMO sniffer 802 clock, for example).

The (synchronized) output of the time and/or frequency synchronization block(s)/module(s) 886 may be provided to one or more deformatters 884. For example, a deformatter 884 may receive an output of the time and/or frequency synchronization block(s)/module(s) 886, remove prefixes, etc., and/or parallelize the data for discrete Fourier transform (DFT) processing.

One or more deformatter 884 outputs may be provided to one or more discrete Fourier transform (DFT) blocks/modules 882. The discrete Fourier transform (DFT) blocks/modules 882 may convert one or more signals from the time domain to the frequency domain. A pilot processor 880 may use the frequency domain signals (per client spatial stream 808, for example) to determine one or more pilot tones (over the client spatial streams 808, frequency subcarriers 874 and/or groups of symbol periods, for example) sent by the base station 804. The pilot processor 880 may additionally or alternatively de-scramble the pilot sequence. The pilot processor 880 may use one or more pilot sequences for phase and/or frequency and/or amplitude tracking.

The pilot tone(s) may be provided to a multiple client space-time-frequency detection and/or decoding block/module 878, which may detect and/or decode the data over the various dimensions for one or more of the MU-MIMO clients. For example, the multiple client space-time-frequency detection and/or decoding block/module 878 may include a control field detection block/module 112, data field detection block/module 114 and/or a data obtaining block/module 116 as described above in connection with FIG. 1.

The multiple client space-time-frequency detection and/or decoding block/module 878 may output received data 876. In one configuration, the multiple client space-time-frequency detection and/or decoding block/module 878 may output received data 876 for a prescribed client. In another configuration, the multiple client space-time-frequency detection and/or decoding block/module 878 may output received data 876 for all MU-MIMO clients. For instance, the multiple client space-time-frequency detection and/or decoding block/module 878 may output an estimation of the payload data 850 and/or overhead data 860 transmitted by the base station 804 for each of the MU-MIMO clients.

In accordance with the systems and methods disclosed herein, the multiple client space-time-frequency detection/decoding block/module 878 may use spatial filtering, MIMO processing and/or other interference rejection techniques to obtain the data 876. For example, when the base station 804 transmits a signal or set of signals to one or more wireless communication devices 318, the MU-MIMO sniffer 802 may receive the signals transmitted to the one or more wireless communication devices 318. Spatial filtering, MIMO processing and/or other interference rejection techniques may be used to recover or separate data 876 intended for a particular wireless communication device 318 (e.g., client) from data intended for one or more other wireless communication device 318. The multiple client space-time-frequency detection/decoding block/module 878 may concurrently output data 876 for each wireless communication device 318.

In some configurations, the MU-MIMO sniffer 802 knows the transmit sequences sent as part of a total information sequence. The MU-MIMO sniffer 802 may perform MU-MIMO channel estimation with the aid of these known transmit sequences. To assist with pilot tone tracking, processing and/or data detection and decoding, a multiple client channel estimation block/module 892 may provide MU-MIMO channel estimation signals to the pilot processor 880 and/or the multiple client space-time-frequency detection and/or decoding block/module 878 based on the output from the time and/or frequency synchronization block/module 886. The multiple client channel estimation block/module 892 may estimate the full MU-MIMO channel for all client spatial streams 108 for all clients. Alternatively, if the de-formatting and discrete Fourier transform are the same (e.g., if channel training and data all use the same subcarriers) for the known transmit sequences as for the payload data portion of the total information sequence, the estimation signals may be provided to the pilot processor 880 and/or the multiple client space-time-frequency detection and/or decoding block/module 878 based on the output from the discrete Fourier transform (DFT) blocks/modules 882.

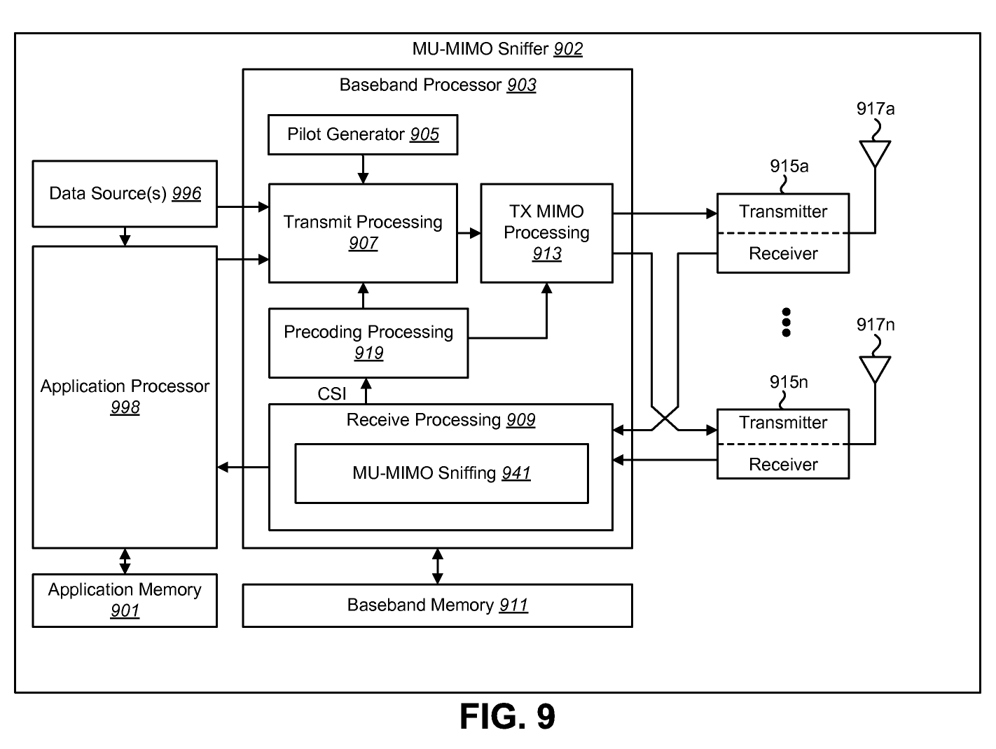

FIG. 9 is a block diagram of a MU-MIMO sniffer 902 in which systems and methods for monitoring wireless communications may be implemented. The MU-MIMO sniffer 902 may be configured similarly to one or more of the MU-MIMO sniffers 102, 302, 502, 802 illustrated above or vice-versa. In the MU-MIMO sniffer 902, traffic data for a number of data streams is provided from one or more data sources 996 and/or an application processor 998 to a baseband processor 903. In particular, traffic data may be provided to a transmit processing block/module 907 included in the baseband processor 903. Each data stream may then be transmitted over one or more transmit antennas 917a-n. The transmit processing block/module 907 may format, code and interleave the traffic data for each data stream based on a particular coding scheme selected for that data stream to provide coded data.

The coded data for each data stream may be multiplexed with pilot data from a pilot generator 905 using orthogonal frequency-division multiplexing (OFDM) techniques. The pilot data may be a known data pattern that is processed in a known manner and used at a receiver to estimate the channel response. The multiplexed pilot and coded data for each stream is then modulated (i.e., symbol mapped) based on a particular modulation scheme (e.g., binary phase shift keying (BPSK), quadrature phase shift keying (QPSK), multiple phase shift keying (M-PSK), quadrature amplitude modulation (QAM) or multi-level quadrature amplitude modulation (M-QAM)) selected for that data stream to provide modulation symbols. The data rate, coding and modulation for each data stream may be determined by instructions performed by a processor.

The modulation symbols for all data streams may be provided to a transmit (TX) multiple-input multiple-output (MIMO) processing block/module 913, which may further process the modulation symbols (e.g., for OFDM). The transmit (TX) multiple-input multiple-output (MIMO) processing block/module 913 then provides a number of modulation symbol streams to the transmitters 915a-n. The TX transmit (TX) multiple-input multiple-output (MIMO) processing block/module 913 may apply beamforming weights to the symbols of the data streams and to the antenna 917a-n from which the symbol is being transmitted.

Each transmitter 915 may receive and process a respective symbol stream to provide one or more analog signals, and further condition (e.g., amplify, filter, and upconvert) the analog signals to provide a modulated signal suitable for transmission over the MIMO channel. Modulated signals from the transmitters 915a-n are then respectively transmitted from the antennas 917a-n. For example, the modulated signal may be transmitted to another communication device (not illustrated in FIG. 11).

The MU-MIMO sniffer 902 may receive modulated signals (from another communication device). These modulated signals are received by antennas 917a-n and conditioned by receivers 915 (e.g., filtered, amplified, downconverted, digitized). In other words, each receiver 915 may condition (e.g., filter, amplify, and downconvert) a respective received signal, digitize the conditioned signal to provide samples, and further process the samples to provide a corresponding “received” symbol stream.

A receive processing block/module 909 included in the baseband processor 903 then receives and processes the received symbol streams from the receivers 915 based on a particular receiver processing technique to provide a number of “detected” streams. The receive processing block/module 909 demodulates, deinterleaves and decodes each stream to recover the traffic data for the data stream.

The receive processing block/module 909 may include a MU-MIMO sniffing block/module 941. The MU-MIMO sniffing block/module 941 may include functionality similar to one or more of the MU-MIMO sniffers 102, 302, 502, 802 illustrated above. For example, the MU-MIMO sniffing block/module 941 may monitor (e.g., decode) MU-MIMO transmissions based on the received symbol streams from the receivers 915. In some configurations, the MU-MIMO sniffer 902 may include a programmable option to operate in a MU-MIMO sniffer mode. The MU-MIMO sniffer 902 may include hardware, software or a combination of both for activating a MU-MIMO sniffer mode. When operating in MU-MIMO sniffer mode, the MU-MIMO sniffing block/module 941 may monitor MU-MIMO transmissions to one or more clients.

A precoding processing block/module 919 included in the baseband processor 903 may receive channel state information (CSI) from the receive processing block/module 909. The precoding processing block/module 919 then determines which pre-coding matrix to use for determining the beamforming weights and then processes the extracted message. It should be noted that the baseband processor 903 may store information on and retrieve information from baseband memory 911.

The traffic data recovered by the baseband processor 903 may be provided to the application processor 998. The application processor 998 may store information in and retrieve information from the application memory 901.

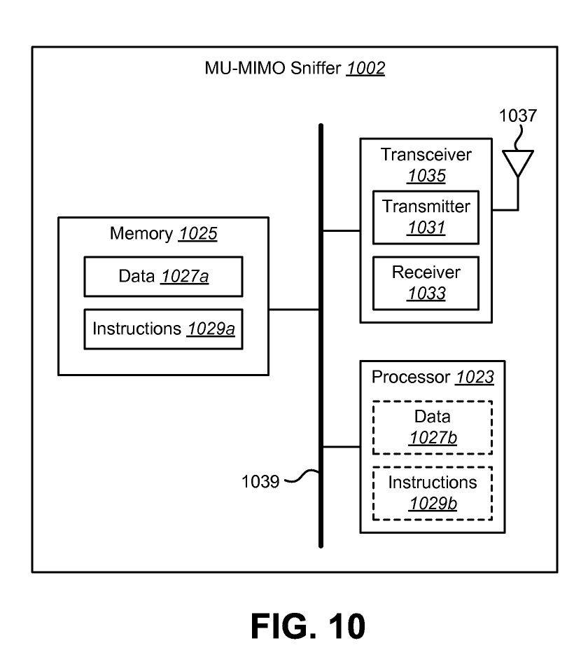

FIG. 10 illustrates certain components that may be included within an MU-MIMO sniffer 1002. One or more of the MU-MIMO sniffers 102, 302, 502, 802, 902 described above may be configured similarly to the MU-MIMO sniffer 1002 that is shown in FIG. 10.

The MU-MIMO sniffer 1002 includes a processor 1023. The processor 1023 may be a general purpose single- or multi-chip microprocessor (e.g., an ARM), a special purpose microprocessor (e.g., a digital signal processor (DSP)), a microcontroller, a programmable gate array, etc. The processor 1023 may be referred to as a central processing unit (CPU). Although just a single processor 1023 is shown in the MU-MIMO sniffer 1002 of FIG. 10, in an alternative configuration, a combination of processors 1023 (e.g., an ARM and DSP) could be used.

The MU-MIMO sniffer 1002 also includes memory 1025 in electronic communication with the processor 1023 (i.e., the processor 1023 can read information from and/or write information to the memory 1025). The memory 1025 may be any electronic component capable of storing electronic information. The memory 1025 may be random access memory (RAM), read-only memory (ROM), magnetic disk storage media, optical storage media, flash memory devices in RAM, on-board memory included with the processor 1023, programmable read-only memory (PROM), erasable programmable read-only memory (EPROM), electrically erasable PROM (EEPROM), registers, and so forth, including combinations thereof.

Data 1027a and instructions 1029a may be stored in the memory 1025. The instructions 1029a may include one or more programs, routines, sub-routines, functions, procedures, code, etc. The instructions 1029a may include a single computer-readable statement or many computer-readable statements. The instructions 1029a may be executable by the processor 1023 to implement one or more of the methods 200, 600, 700 described above. Executing the instructions 1029a may involve the use of the data 1027a that is stored in the memory 1025. FIG. 10 shows some instructions 1029b and data 1027b being loaded into the processor 1023 (which may come from instructions 1029a and data 1027a in memory 1025).

The MU-MIMO sniffer 1002 may also include a transmitter 1031 and a receiver 1033 to allow transmission and reception of signals between the MU-MIMO sniffer 1002 and a remote location (e.g., a communication device, base station, etc.). The transmitter 1031 and receiver 1033 may be collectively referred to as a transceiver 1035. An antenna 1037 may be electrically coupled to the transceiver 1035. The MU-MIMO sniffer 1002 may also include (not shown) multiple transmitters 1031, multiple receivers 1033, multiple transceivers 1035 and/or multiple antennas 1037.

In some configurations, the MU-MIMO sniffer 1002 may include one or more microphones for capturing acoustic signals. In one configuration, a microphone may be a transducer that converts acoustic signals (e.g., voice, speech) into electrical or electronic signals. Additionally or alternatively, the MU-MIMO sniffer 1002 may include one or more speakers. In one configuration, a speaker may be a transducer that converts electrical or electronic signals into acoustic signals.

The various components of the MU-MIMO sniffer 1002 may be coupled together by one or more buses, which may include a power bus, a control signal bus, a status signal bus, a data bus, etc. For simplicity, the various buses are illustrated in FIG. 10 as a bus system 1039.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer or processor. Disk and disc, as used herein, include compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL) or wireless technologies such as infrared, radio and microwave, then the coaxial cable, fiber optic cable, twisted pair, DSL or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 2, FIG. 6 and FIG. 7, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for multi-user multiple-input and multiple-output (MU-MIMO) sniffing by an electronic device, comprising:
detecting multiple client second control fields concurrently;
detecting multiple client data fields concurrently; and
obtaining data based on the multiple client data fields.

2. The method of claim 1, wherein the multiple client second control fields are multiple client very high throughput signal B (VHT-SIG-B) fields.

3. The method of claim 1, wherein the multiple client data fields are multiple client very high throughput (VHT) data fields.

4. The method of claim 1, further comprising deparsing signaling parameters from multiple client first control fields.

5. The method of claim 4, wherein the multiple client first control fields are very high throughput signal A (VHT-SIG-A) fields.

6. The method of claim 4, wherein deparsing signaling parameters from multiple client first control fields is performed for a client number and further comprises deparsing a number of client spatial streams for all other MU-MIMO clients.

7. The method of claim 1, further comprising obtaining a MU-MIMO channel estimate for multiple client spatial streams.

8. The method of claim 7, wherein detecting multiple client second control fields is based on the MU-MIMO channel estimate.

9. The method of claim 1, further comprising decoding the multiple client second control fields.

10. The method of claim 1, further comprising deparsing multiple client modulation and coding schemes (MCSs) from the multiple client second control fields.

11. The method of claim 1, wherein obtaining data based on the multiple client data fields comprises performing at least one of deinterleaving, decoding and descrambling for each of the multiple client data fields.

12. A multi-user multiple-input and multiple-output (MU-MIMO) sniffer, comprising:
control field detection circuitry that detects multiple client second control fields concurrently;
data field detection circuitry coupled to the control field detection circuitry, wherein the data field detection circuitry detects multiple client data fields concurrently; and
data obtaining circuitry coupled to the data field detection circuitry, wherein the data obtaining circuitry obtains data based on the multiple client data fields.

13. The MU-MIMO sniffer of claim 12, wherein the multiple client second control fields are multiple client very high throughput signal B (VHT-SIG-B) fields.

14. The MU-MIMO sniffer of claim 12, wherein the multiple client data fields are multiple client very high throughput (VHT) data fields.

15. The MU-MIMO sniffer of claim 12, further comprising signal parameter deparsing circuitry coupled to the control field detection circuitry, wherein the signal parameter deparsing circuitry deparses signaling parameters from multiple client first control fields.

16. The MU-MIMO sniffer of claim 15, wherein the multiple client first control fields are very high throughput signal A (VHT-SIG-A) fields.

17. The MU-MIMO sniffer of claim 15, wherein deparsing signaling parameters from multiple client first control fields is performed for a client number, and wherein the signal parameter deparsing circuitry deparses a number of client spatial streams for all other MU-MIMO clients.

18. The MU-MIMO sniffer of claim 12, further comprising channel estimation circuitry coupled to the control field detection circuitry, wherein the channel estimation circuitry obtains a MU-MIMO channel estimate for multiple client spatial streams.

19. The MU-MIMO sniffer of claim 18, wherein detecting multiple client second control fields is based on the MU-MIMO channel estimate.

20. The MU-MIMO sniffer of claim 12, further comprising control field decoding circuitry coupled to the control field detection circuitry, wherein the control field decoding circuitry decodes the multiple client second control fields.

21. The MU-MIMO sniffer of claim 12, further comprising modulation and coding scheme (MCS) deparsing circuitry coupled to the data field detection circuitry, wherein the MCS deparsing circuitry deparses multiple MCSs from the multiple client second control fields.

22. The MU-MIMO sniffer of claim 12, wherein obtaining data based on the multiple client data fields comprises performing at least one of deinterleaving, decoding and descrambling for each of the multiple client data fields.

23. A computer-program product for multi-user multiple-input and multiple-output (MU-MIMO) sniffing, comprising a non-transitory tangible computer-readable medium having instructions thereon, the instructions comprising:
code for causing a MU-MIMO sniffer to detect multiple client second control fields concurrently;
code for causing the MU-MIMO sniffer to detect multiple client data fields concurrently; and
code for causing the MU-MIMO sniffer to obtain data based on the multiple client data fields.

24. The computer-program product of claim 23, wherein the multiple client second control fields are multiple client very high throughput signal B (VHT-SIG-B) fields.

25. The computer-program product of claim 23, wherein the multiple client data fields are multiple client very high throughput (VHT) data fields.

26. The computer-program product of claim 23, the instructions further comprising code for causing the MU-MIMO sniffer to deparse signaling parameters from multiple client first control fields.

27. The computer-program product of claim 26, wherein the multiple client first control fields are very high throughput signal A (VHT-SIG-A) fields.

28. The computer-program product of claim 26, wherein deparsing signaling parameters from multiple client first control fields is performed for a client number and further comprises deparsing a number of client spatial streams for all other MU-MIMO clients.

29. The computer-program product of claim 23, the instructions further comprising code for causing the MU-MIMO sniffer to obtain a MU-MIMO channel estimate for multiple client spatial streams.

30. The computer-program product of claim 29, wherein detecting multiple client second control fields is based on the MU-MIMO channel estimate.

31. The computer-program product of claim 23, the instructions further comprising code for causing the MU-MIMO sniffer to decode the multiple client second control fields.

32. The computer-program product of claim 23, the instructions further comprising code for causing the MU-MIMO sniffer to deparse multiple client modulation and coding schemes (MCSs) from the multiple client second control fields.

33. The computer-program product of claim 23, wherein obtaining data based on the multiple client data fields comprises code for causing the MU-MIMO sniffer to perform at least one of deinterleaving, decoding and descrambling for each of the multiple client data fields.

34. An apparatus for multi-user multiple-input and multiple-output (MU-MIMO) sniffing, comprising:
means for detecting multiple client second control fields concurrently;
means for detecting multiple client data fields concurrently; and
means for obtaining data based on the multiple client data fields.

35. The apparatus of claim 34, wherein the multiple client second control fields are multiple client very high throughput signal B (VHT-SIG-B) fields.

36. The apparatus of claim 34, wherein the multiple client data fields are multiple client very high throughput (VHT) data fields.

37. The apparatus of claim 34, further comprising means for deparsing signaling parameters from multiple client first control fields.

38. The apparatus of claim 37, wherein the multiple client first control fields are very high throughput signal A (VHT-SIG-A) fields.

39. The apparatus of claim 37, wherein deparsing signaling parameters from multiple client first control fields is performed for a client number and further comprises deparsing a number of client spatial streams for all other MU-MIMO clients.

40. The apparatus of claim 34, further comprising means for obtaining a MU-MIMO channel estimate for multiple client spatial streams.

41. The apparatus of claim 40, wherein detecting multiple client second control fields is based on the MU-MIMO channel estimate.

42. The apparatus of claim 34, further comprising means for decoding the multiple client second control fields.

43. The apparatus of claim 34, further comprising means for deparsing multiple client modulation and coding schemes (MCSs) from the multiple client second control fields.

44. The apparatus of claim 34, wherein obtaining data based on the multiple client data fields comprises means for performing at least one of deinterleaving, decoding and descrambling for each of the multiple client data fields.
